(19) United States
(12) Patent Application Publication
(10) Pub. No.: US 2008/0080681 A1
(43) Pub. Date: Apr. 3, 2008

(54) PERSONALIZED VOICE MAIL ENDORSEMENTS

(76) Inventors: John M. Burgan, North Palm Beach, FL (US); Joseph Patino, Pembroke Pines, FL (US); Russell L. Simpson, Miami, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(21) Appl. No.: 11/536,698

(22) Filed: Sep. 29, 2006

(51) Int. Cl. H04M 1/64

(52) U.S. Cl. 379/88.22

(57) ABSTRACT

A server (122) provides at least one advertisement choice (404) to a user and receives a selection of the at least one advertisement choice from the user. An endorsement is then created from the selected advertisement choice and linked to a voice mail service subscribed to by the user. When a call is received from an originating device (106), the endorsement is played in association with an outgoing voice mail message to a user of the originating device.

### BACKGROUND OF THE INVENTION

1. Field of the Invention

The present invention relates generally to the field of wireless devices, and more particularly relates to attaching advertising content to voice-mail services.

2. Background of the Invention

Most wireless-service providers charge their subscribers on a use basis. Under a use-based plan, the subscriber's monthly bill is at least partially based on the number of service units (usually minutes) used within a defined period of time (usually a month). Minutes of service are generally defined to be any minute, or portion of a minute, a subscriber is actively connected to the wireless network, such as when placing or receiving a call, downloading or uploading data to the internet, instant messaging, and others.

In order to be competitive, wireless service providers commonly include a voice mail feature with their calling plans at no additional charge to the subscriber. However, when a user is retrieving voice mail, he consumes air-time minutes and other resources from the service provider. If the carrier does not charge for air time to retrieve voice mail, he is losing air time capability with no revenue generated. It on the other hand, the carrier does charge for voice mail air time, the consumer is dissatisfied with the service provider because he is paying the same rate to record or retrieve messages as he would pay for a full conversation.

Additionally, when others are leaving voice mail messages for the subscriber, they are consuming resources from the subscriber's provider. However, it is highly unlikely that one would be able to successfully charge others to leave messages for the provider's subscribers.

Furthermore carriers often offer “in network” calling discounts, where subscriber-to-subscriber calls are discounted or free. However, this discount may not apply when the call initiator leaves the voicemail recording, or when the recipient retrieves the voice mail message. In these cases the subscribers may pay higher fees for voicemail than for a regular call.

Therefore, there is a need for a method to generate revenue from users leaving or retrieving voice mail without charging them directly.

### SUMMARY OF THE INVENTION

Briefly, in accordance with an embodiment of the present invention, disclosed is a method for linking an endorsement to a voice mail message, where at least one advertisement choice is presented to a user and a user selects one of the choices. An endorsement is then created from the selected advertisement choice linked to a voice mail service subscribed to by the user.

In accordance with another mode of the invention, a call is received from an originating device and the endorsement is then played in association with an outgoing voice mail message to a user of the originating device.

In accordance with a further mode of the present invention, the particular user selected advertisement choice to play as part of the outgoing message is determined in part by the call history of the originating device.

In accordance with an additional mode of the invention, at least one advertising attribute is selected for at least one of the advertising choices. Examples of possible advertisement attributes are demographics, competing products, and a quantity of repeat plays.

In accordance with yet another mode of the invention, when a call is received from an originating device, at least one attribute associated with an identifier of the originating device is compared to the at least one advertising attribute and which of a plurality of selected advertisement choices to play as part of an outgoing message is determined based on the comparison.

In accordance with yet a further mode of the invention, compensation is received from an advertiser for the user's selection of the advertising choice.

In accordance with yet an added mode of the invention, a call is initiated to a destination device and the endorsement is played as part of a message left to a destination device user.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an overall system diagram illustrating one embodiment of a mobile communication network in accordance with the present invention.

FIG. 2 is a hardware block diagram illustrating one embodiment of a server in accordance with the present invention.

FIG. 3 is a flow diagram of a process for making advertisement available to users in accordance with the present invention.

FIG. 4 illustrates an input screen for assigning attributes to advertising content in accordance with the present invention.

FIG. 5 is a flow diagram of a process for attaching endorsements to a voice mail outgoing message in accordance with the present invention.

FIG. 6 is a flow diagram of a process of playing endorsements in accordance with the present invention.

FIG. 7 is a flow diagram of a process of cross-referencing attributes of items endorsed by an originating caller and attributes of items endorsed by a destination-device user in accordance with the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward.

Overview

Voice mail is so prevalent today that the term is understood by almost every person and is included in virtually every wireless service plan as a basic feature. Voice mail allows one to leave, receive, edit, save, and forward messages to one or more voice mailboxes in a user's company or universe of friends and contacts. The need for voice mail is obvious. It is just not possible for one to answer their phone every time it rings. In addition, due to network or equipment problems, a destination wireless device cannot always be found to complete the call. Therefore, a large number of calls are not completed on the first attempt. In addition, many of those calls are for one-way transfers of information anyway. Embodiments of the present invention utilize paid-for endorsements to offset the cost of voicemail services.

The idea of attaching advertising to various communications methods to generate revenue is ubiquitous. Newspapers, television, and web pages are a few prime examples. In many cases, the advertising is even tailored to the particular viewer (e.g., internet search engine tailors advertising to match the search topic). The present invention overcomes problems with the prior art by allowing providers of wireless services to utilize advertising to generate revenue from users leaving or retrieving voice mail. Advantageously, the wireless service providers do not charge the users directly. Embodiments of the present invention provide a system that allows personalized endorsements to be attached to a voice mail message, thereby deferring the cost of operating the voice mail system and adding revenue for the carrier.

System Diagram

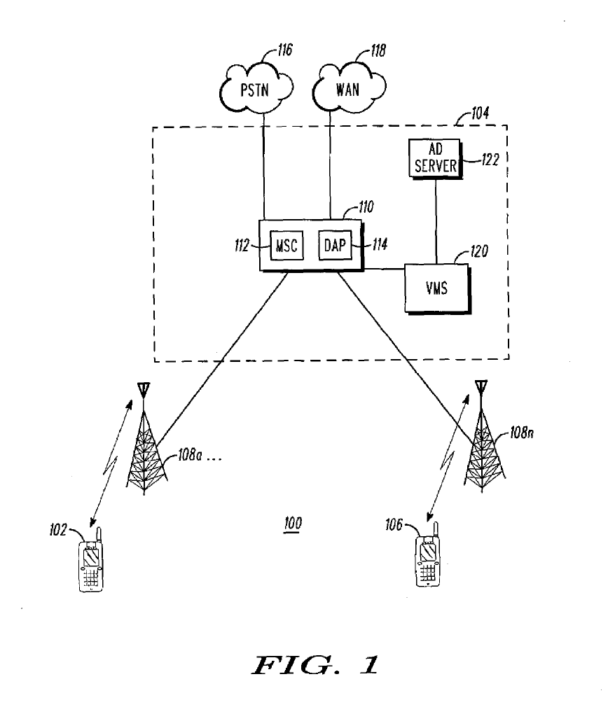

Referring now to FIG. 1, there is shown a system diagram of a communication system 100 for supporting the attachment of endorsements to voicemail services in accordance with the present invention. A first mobile communication device 102 is used by a first user. The first mobile communication device communicates with a communication system infrastructure 104 and is able to link to a second mobile communication device 106. The communication system infrastructure includes base stations 108a-n which establish service areas in the vicinity of the base station to support wireless mobile communication, as is known in the art.

The base stations 108a-n communicate with a central office 110 which includes call processing equipment for facilitating communication among mobile communication devices and between mobile communication devices and parties outside the communication system infrastructure, such as mobile switching center 112 for processing mobile telephony calls, and a dispatch application processor 114 for processing dispatch or half duplex communication.

The central office 110 is further operably connected to a public telephone switching network (PTSN) 116 to connect calls between the mobile communication devices within the communication system infrastructure and telephone equipment outside the system 100. Furthermore, the central office 110 provides connectivity to a wide area data network (WAN) 118, which may include connectivity to the Internet.

When an origination device 102 places a call to a destination device 106 using the destination device's phone number, the central office 110 attempts to route the call to the destination device 106. However, if the destination device is not available (i.e., turned off or out of network), engaged in an active call to another device, or the user chooses not to answer an incoming call, the central office 110 will route the call to a voice mail server (VMS) 120, which answers the incoming call. The VMS 120 provides storage and playback of voice mail messages, both incoming and outgoing, for a multitude of users. The VMS 120 provides services that vary from simple to complex. Typically a brief message is played and then the originating device user is allowed to leave a message for the destination device user. The message is played back to the destination device user when the user queries the system. Some voicemail services do not allow a user to leave a message at all, while others present the caller with a menu of options, such as leaving a return phone number, sending a text message, and others.

The present invention also provides an advertisement server 122 that is communicatively coupled to the VMS 120. The advertisement server 122 is shown in FIG. 1. The advertisement server 122 stores advertisements, which, in at least one embodiment of the present invention, are voice files. The advertisements can also be sounds, such as music or tones. The advertisement server 122 is accessible by advertisers that wish to place advertising content on the server 122 so that the content can ultimately be attached to voicemail messages in accordance with embodiments of the present invention. To place, delete, and manipulate the content, the advertisers can access the advertisement server 122 in any known way, such as via the internet, phone lines, a terminal or user interface connected to the server, or others. The types of content and its uses are explained below.

In FIG. 1 the VMS 120 and the advertisement server 122 are illustrated as individual servers. Those of ordinary skill in the art will recognize that the functions performed by each server 120, 122 can be performed by a single server containing hardware and running software that contains the functions described herein for each server 120, 122. The VMS 120 and the advertisement server 122 should be broadly construed to mean a computer, computer platform, a computer system, or any component thereof.

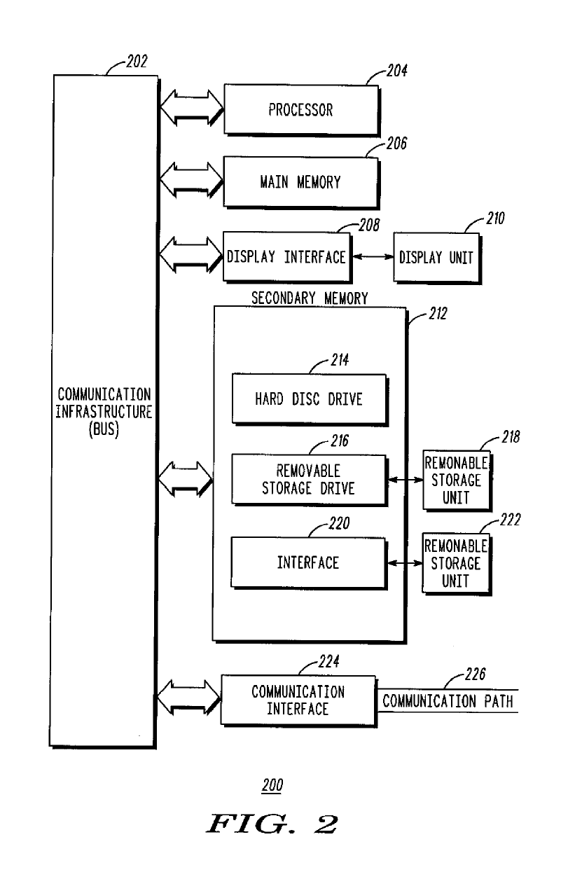

FIG. 2 is a high level block diagram illustrating a more detailed view of VMS 120 and advertising server 122, according to embodiments of the present invention, and more particularly, showing an information processing system 200 useful for implementing one of the servers 120, 122. The information processing system 200, in one embodiment, resides outside of and is communicatively coupled to its respective server. In another embodiment, the information processing system 200 resides within its respective server. The information processing system 200 is based upon a suitably configured processing system adapted to implement the exemplary embodiment of the present invention. Any suitably configured processing system is similarly able to be used as the information processing system 200 by embodiments of the present invention. For example, a personal computer, workstation, or the like, may be used.

In one embodiment of the present invention, the computer system 200 includes one or more processors, such as processor 204. The processor 204 is connected to a communication infrastructure 202 (e.g., a communications bus, cross-over bar, or network). Various software embodiments are described in terms of this exemplary computer system. After reading this description, it will become apparent to those of ordinary skill in the art how to implement the invention using other computer systems and/or computer architectures.

The computer system 200 can include a display interface 208 that forwards graphics, text, and other data from the communication infrastructure 202 (or from a frame buffer) for display on the display unit 210. The computer system also includes a main memory 206, preferably random access memory (RAM), and may also include a secondary memory 212. The secondary memory 212 may include, for example, a hard disk drive 214 and/or a removable storage drive 216, representing a floppy disk drive, a magnetic tape drive, an optical disk drive, etc. The removable storage drive 216 reads from and/or writes to a removable storage unit 218 in a manner well known to those having ordinary skill in the art. Removable storage unit 218, represents a floppy disk, a compact disc, magnetic tape, optical disk, etc. which is read by and written to by removable storage drive 216. As will be appreciated, the removable storage unit 218 includes a computer readable medium having stored therein computer software and/or data. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer-readable information.

In alternative embodiments, the secondary memory 212 may include other similar means for allowing computer programs or other instructions to be loaded into the computer system. Such means may include, for example, a removable storage unit 222 and an interface 220. Examples of such may include a program cartridge and cartridge interface (such as that found in video game devices), a removable memory chip (such as an EPROM, or PROM) and associated socket, and other removable storage units 222 and interfaces 220 which allow software and data to be transferred from the removable storage unit 222 to the computer system.

The computer system, in this example, includes a communications interface 224 that allows software and data to be transferred between the computer system and external devices or and the communication center 110 via a communications path 226. Examples of communications interface 224 may include a modem, a network interface (such as an Ethernet card), a communications port, a PCMCIA slot and card, T1 line, etc. Software and data transferred via communications interface 224 are in the form of signals which may be, for example, electronic, electromagnetic, optical, or other signals capable of being received by communications interface 224. These signals are provided to communications interface 224 via a communications path (i.e., channel) 226. This channel 226 carries signals and may be implemented using wire or cable, fiber optics, a phone line, a cellular phone link, an RF link, and/or other communications channels.

The VMS 120 and the advertisement server 122 run, or execute, software that allows the servers 120, 122 to properly handle and process client requests, in addition to other processes necessary for the servers 120, 122 to perform their required functions. In this document, the terms “computer program medium,” “computer usable medium,” and “computer readable medium” are used to generally refer to media such as main memory 206 and secondary memory 212, removable storage drive 216, a hard disk installed in hard disk drive 214, and signals. These computer program products are means for providing software to the computer system. The computer readable medium allows the computer system to read data, instructions, messages or message packets, and other computer readable information from the computer readable medium.

The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

Endorsements

As will now be described in detail, embodiments of the present invention provide the attachment of personalized endorsements to voicemail services.

Advertising Content

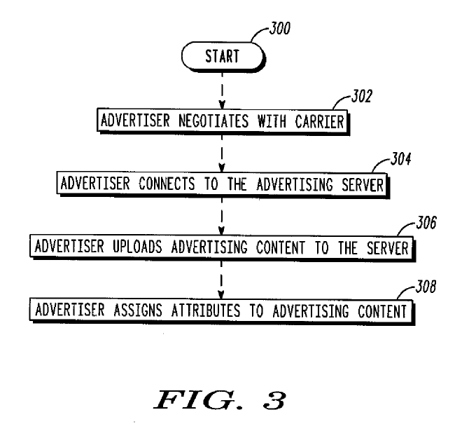

Advertisers wishing to participate in a program that, in this example, allows their advertising to be heard by users of a voice mail system enter into relationships with wireless service providers and then make their content available to subscribers for selection. FIG. 3 illustrates one embodiment of the steps for the advertisers to make this advertising content available for user selection. The flow begins at step 300 and moves directly to step 302, where a company wishing to advertise negotiates with the carrier to allow their advertising to be placed on the advertising server 122. The advertising will typically be audio voice messages, sounds, or music that is associated with a product or service and will create goodwill toward that product or service. However, the invention is not so limited and “advertising” should be broadly construed to include political announcements, private announcements, public announcements, and any other messages or associated audible material, whether traditional or non-traditional advertising-type material. Additionally, while the present example uses audible advertisement material, it should be obvious to those of ordinary skill in the art that visual advertisement material, and/or tactile or vibrating advertising signals, may be used or a combination of audible and visual, and tactile signals in a multimedia advertisement message.

Next, in step 304 an advertiser connects to the advertising server 122. The connection can be wired or wireless and can include any known method of communicating with a computer. The advertiser uploads, in step 306, advertising content to the server 122, where it is stored or indexed so that it can be stored in a remote memory location. In other embodiments, the advertising content is stored on a server maintained by the advertiser and addressed by the advertising server 122. The content, in this example, can be as simple as text or can be sounds, music, vocals, or other media files. The advertiser can then assign one or more attributes to the advertising content in step 308.

Attributes

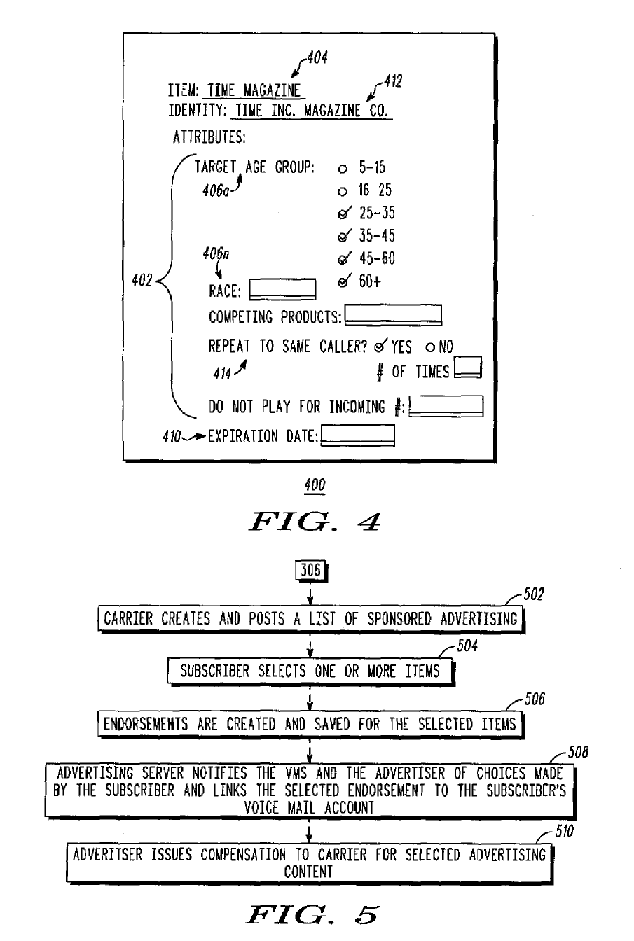

FIG. 4 shows an exemplary input screen 400, where an advertiser can assign attributes 402 to advertising content 404. Examples of attributes are user demographics 406a-n, competing products 408a-n, expiration date of advertisement content 410, the advertiser's identity 412, whether an endorsement for the advertising material should be repeated to the same incoming number if other advertisements are also available 414, and others. The attributes can be referenced by the advertising server 122 to determine which incoming callers selected endorsements should be played to. The use of the attributes, however, is not necessary.

Attaching Endorsements

FIG. 5 illustrates one embodiment of the steps for attaching endorsements to a voice mail outgoing message. The flow begins at step 502, which follows step 306, shown in FIG. 3. In step 502, the carrier creates a list of sponsoring advertisers and/or products and/or services and posts them in a space that is accessible to subscribers, such as advertising server 122. In one embodiment, the list is posted on the carrier's web page for subscribers to view and select. In other embodiments, the list is accessible and selectable via telephone, at in-store locations, via U.S. mail or email, or others.

A subscriber then goes to the particular location, in step 504, and selects one or more of the advertising choices, i.e., products, services, or others, that he wishes to endorse. The server receives the subscriber's choices via an input, which can he any network connection that receives information or electrical pulses to indicate a choice. In certain embodiments, the advertisers themselves create the spaces, such as web pages, where the subscribers can go to select the products or services to endorse. In one embodiment of the present invention, the subscriber's name and other information, such as age and race, is provided to the advertiser or stored in a location that is accessible to the advertiser. The advertiser then makes use of the user's name or other information to create personalized endorsements, in step 506. In other embodiments, the subscriber actually records his or her voice to create a personal endorsement of a product or service. An example of a “personal” endorsement is “Hi, this is James and I can't get enough Twix bars.” An example of a “personalized” endorsement is “James enjoys Twix bars.” The endorsements are recorded and stored on the advertising sever 122, the VMS 120, or elsewhere. Other endorsements are simply selecting a product or services' jingle or trademark sounds, and/or visuals, and/or tactile signals, to be played in the background of an outgoing message.

In step 508, the advertising server 122 indicates to the VMS 120 and the advertiser, or makes available to the VMS 120 and the advertiser, the choices made by the subscriber and links the selected endorsement to the subscriber's voice mail account. The term “link” as used herein is intended to mean any way of causing two items to be associated with each other. It should also be noted that the advertising server 122 and the VMS 120 are not necessarily separate entities and can be, or reside on, a single server. At the conclusion of step 508, the subscriber's voice mail is properly set up and ready for incoming calls. The advertiser then, in step 510, issues compensation to the voice mail carrier for the advertising content having been linked to a voice mail account. In other embodiments, the carrier is not compensated until the advertising content has been actually played to an incoming caller.

In an embodiment of the present invention, the user is able to make preferential settings when selecting an endorsement subject, such as listing particular phone numbers for the endorsement to be played to or not be played to. The user can select options for how to cycle certain endorsements also, such as random or sequential.

Playing Endorsements

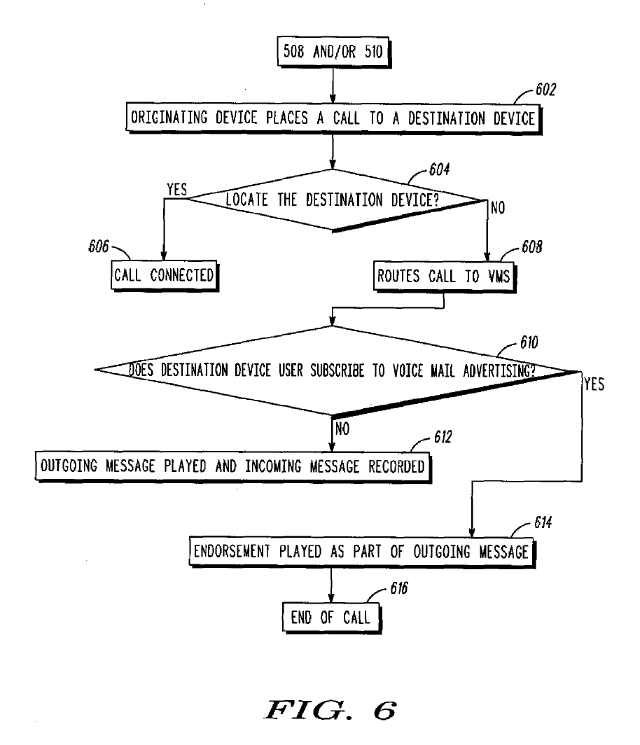

FIG. 6 illustrates the steps, according to one example, for playing the endorsements selected in FIG. 5. The flow starts at step 602, which takes place after step 508 and/or step 510 of FIG. 5 is complete. In step 602, an originating device 102 places a call to a destination device 106 through central office 110, shown in FIG. 1. The central office 110 resolves the phone number and attempts to locate the destination device 106 in step 604. If the destination device is located, the call is connected in step 606 and the devices are able to communicate. If the destination device 106 does not answer the call, the central office 110 routes call to the VMS 120, which answers the call in step 608.

In step 610, the system 104 checks to see if the user of the destination device 106 has subscribed to voice mail advertising. If the user has not, an outgoing message is played, in step 612, for the caller and the caller's incoming message, if any, is recorded. If the user of the destination device 106 has subscribed to voice mail advertising, the system 104 plays an endorsement as part of an outgoing message, in step 614. The outgoing message includes the endorsement before, during or after an invitation for a caller to leave a message. However, the invitation is not always present. For example, if the subscriber picked Coca Cola from the list of available advertisement choices as a product that she personally supports, her voice mail message would carry a message attachment automatically inserted by the VMS 120 that says “Jennifer Smith prefers Coca Cola” as either a signature or an introduction. In other embodiments, a previously stored endorsement in the subscriber's own voice is played that says, for example, “This is Jennifer Smith and I prefer Coca Cola. Leave me a message if you do too.” The caller's message, if any, can then be recorded. The call is terminated in step 616.

Those skilled in the art will recognize that the type of advertising message can be varied as desired by the carrier, subscriber, or advertiser. For example, instead of a vocal endorsement of the product, the advertiser's theme song could be added as background music behind the voice mail message, as an intro, or an ending. In return for carrying the advertising sponsorship the charge to the subscriber for leaving or retrieving the voice mail will be reduced or eliminated, and instead a charge to the sponsor's advertising account will be made by the carrier.

In embodiments of the present invention, a subscriber can return to the space designated by the advertiser, e.g., an internet page, and select additional products or services to endorse or de-select previously selected items.

In one embodiment, a record is created each time an advertisement is played from a subscriber's voice mail account. The record can be a table, for example, that stores fields identifying the originating user or device, the incoming phone number, the advertisement played, whether the advertisement was played in its entirely, the date and time the advertisement was played, and other details of the process of the present invention. The record can then later be used by the provider to charge the advertiser, and/or credit the subscriber. The record can also be used to avoid playing the same endorsement twice for the same incoming caller if other endorsements are available that have not yet been heard by that particular incoming caller.

Caller Registration

In other embodiments of the present invention, the incoming caller is registered with the advertising server 122 also. Since both the originating caller and the destination caller are known, when a call is placed, the two numbers are cross referenced on the advertising server for attributes that have been set for each user and associated advertising preferences.

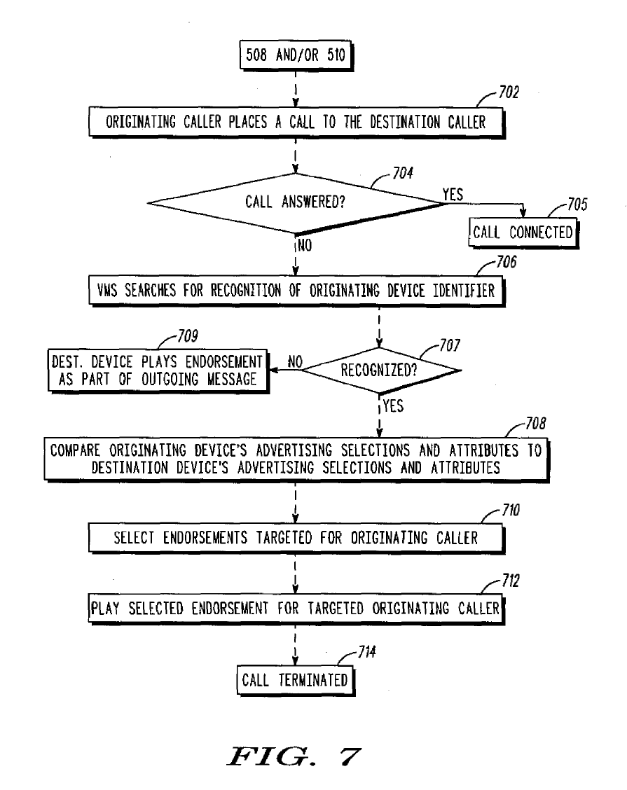

FIG. 7 illustrates an exemplary process for cross-referencing attributes assigned to advertising by both an incoming caller and the destination caller. Prior to the first step 702, of FIG. 7, both the originating caller and the destination caller follow the steps illustrated in FIG. 5 for attaching endorsements to voice mail accounts. Therefore, the flow starts at step 702, which takes place after step 508 and/or step 510 of FIG. 5 is complete. In step 702, the originating caller places a call to the destination caller. If the call is answered 704 by a user of the destination device, the call is connected and the flow stops at step 705. If the call is not answered 704 by the user of the destination device, the call is routed to the VMS 120, which, in step 706, searches a registration database for recognition of an identifier of the originating device. In one embodiment of the present invention, the database is stored on the advertising server 122. Recognition of the identifier of the originating device indicates that the originating device is registered with an advertising service.

If the identifier is not recognized, in step 707, the flow moves to step 709, where the destination device attaches an endorsement to its outgoing message. If the identifier is recognized in step 707, the originating device's advertising selections and their attributes are compared to advertising selections and attributes of the destination device in step 708. Exemplary attributes are demographics of the incoming caller, competing products of the advertisements selected, the number of times an endorsement should be replayed to the same caller, and others. The present invention is then able to, in step 710, select endorsements for products, services, or political issues that are strategically targeted for the originating caller. For instance, if one of the destination caller's endorsement choices is Coca Cola and one of the originating caller's endorsement choices is the directly competing product Pepsi Cola, it is probably useless to play a Coca Cola endorsement for the incoming caller. Therefore, if possible, a non-directly competing endorsement can be played to the originating caller. Additionally, it is possible to avoid repeating an endorsement to an originating caller if other endorsements are available. In step 712, the selected endorsement is played for the originating caller. The process ends at step 714, when the call is terminated.

In an alternative embodiment of the present invention, the originating caller can leave an endorsement as the message or part of the message left on the destination device's voice server 120. For example, the VMS 120 automatically appends an endorsement to the voice mail message as it is being stored on the VMS 120 for later playback to the destination device owner. In this way, both the incoming caller and the receiving caller have opportunities to listen to endorsements of the other.

As described above, one embodiment of the present invention provides a way for advertisers to reach an untapped audience, service providers to receive compensation for providing an advertising medium, and subscribers to get voicemail services at a reduced or no cost. Callers are introduced to personalized endorsements of products, services, and other subject matter supported by the called user and are also, in some embodiments of the present invention, able to leave personalized endorsements of products they support on the voice mail of the called user's device.

Reference throughout the specification to “one embodiment” means that a particular feature, structure, or characteristic described in connection with the embodiment is included in at least one embodiment of the present invention. Thus, the appearances of the phrases “in one embodiment” in various places throughout the specification are not necessarily all referring to the same embodiment. Furthermore, the particular features, structures, or characteristics may be combined in any suitable manner in one or more embodiments. Moreover these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and visa versa with no loss of generality.

While the various embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for linking an endorsement to a voice mail message, the method comprising:
providing at least one advertisement choice to a user;
receiving a selection of the at least one advertisement choice from the user;
creating an endorsement from the selected advertisement choice; and
linking the endorsement to a voice mail service subscribed to by the user.

2. The method according to claim 1, further comprising:
receiving a call from an originating device; and
playing the endorsement in association with an outgoing voice mail message to a user of the originating device.

3. The method according to claim 1, further comprising:
determining which of a plurality of user selected advertisement choices to play as part of an outgoing message to the originating device based on a call history of the originating device.

4. The method according to claim 1, further comprising:
selecting at least one advertising attribute of the at least one advertising choice.

5. The method according to claim 4, wherein the at least one advertising attribute is at least one of:
a demographic;
a competing product; and
a quantity of repeat plays.

6. The method according to claim 4, further comprising:
receiving a call from an originating device;
comparing at least one attribute associated with an identifier of the originating device to the at least one advertising attribute; and
determining which of a plurality of selected advertisement choices to play as part of an outgoing message, the determination based on the comparison.

7. The method according to claim 1, further comprising
receiving compensation from an advertiser for receiving the selection.

8. The method according to claim 1, further comprising:
initiating a call to a destination device; and
playing the endorsement as part of a message left to a destination device user.

9. A system for attaching endorsements to voice mail messages, the system comprising:
a server accessible by a user and providing at least one advertisement choice to the user;
an input for receiving a selection of the at least one advertisement choice from the user; and
a memory for storing an endorsement corresponding to a voice mail account and created from the selected advertisement choice.

10. The system according to claim 9, further comprising:
an input for receiving a call from an originating device; and
an output for playing the endorsement in association with an outgoing voice mail message to a user of the originating device.

11. The system according to claim 9, further comprising:
a processor for determining which of a plurality of selected advertisement choices to play as part of an outgoing message to the originating device based on a call history of the originating device.

12. The system according to claim 9, further comprising:
an input for selecting at least one advertising attribute of the at least one advertising choice.

13. The system according to claim 12, further comprising:
an input for receiving a call from an originating device;
a comparator for comparing at least one attribute associated with an identifier of the originating device to the at least one advertising attribute; and
a processor, communicatively coupled to the comparator, for determining which of a plurality of selected advertisement choices to play as part of an outgoing message, the determination based on the comparison.

14. The system according to claim 9, further comprising
an input for receiving compensation from an advertiser for receiving the selection.

15. The system according to claim 1, further comprising:
an output for initiating a call to a destination device and outputting the endorsement as part of a message left to a destination device user.

16. A computer program product for attaching endorsements to voice mail messages, the computer program product comprising:
a storage medium readable by a processing circuit and storing instructions for execution by the processing circuit for performing a method comprising:
providing at least one advertisement choice to a user;
receiving a selection of the at least one advertisement choice from the user;
creating an endorsement from the selected advertisement choice; and
linking the endorsement to a voice mail service subscribed to by the user.

17. The computer program product according to claim 16, further comprising:
receiving a call from an originating device; and
playing the endorsement as at least a portion of an outgoing voice mail message to a user of the originating device.

18. The computer program product according to claim 16, further comprising:
determining which of a plurality of selected advertisement choices to play as part of an outgoing message to the originating device based on a call history of the originating device.

19. The computer program product according to claim 16, further comprising:
selecting at least one advertising attribute of the at least one advertising choice.

20. The computer program product according to claim 19, further comprising:
receiving a call from an originating device;
comparing at least one attribute associated with an identifier of the originating device to the at least one advertising attribute; and
determining which of a plurality of selected advertisement choices to play as part of an outgoing message, the determination based on the comparison.
